(19) United States
(12) Patent Application Publication
(10) Pub. No.: US 2012/0254477 A1
(43) Pub. Date: Oct. 4, 2012

(54) MANAGING DATA STORAGE IN A DISTRIBUTED STORAGE SPACE

(75) Inventors: Anthony Foulonneau, Rennes (FR); Alain Dechorgnat, Saint Gregoire (FR)

(73) Assignee: France Telecom, Paris (FR)

(21) Appl. No.: 13/502,027

(22) PCT Filed: Oct. 11, 2010
(86) PCT No.: PCT/FR2010/052139

§ 371 Date: Jun. 15, 2012

(30) Foreign Application Priority Data
Oct. 13, 2009 (FR) 0957151

(51) Int. Cl. G06F 3/00

(52) U.S. Cl. 710/14

(57) ABSTRACT

A method and apparatus are provided for selecting at least one device for manipulating data. The at least one device is selected from a plurality of devices forming a distributed storage space. Selection of a device includes taking account of at least one item of technical information associated with the device.

### CROSS-REFERENCE TO RELATED APPLICATIONS

This Application is a Section 371 National Stage Application of International Application No. PCT/FR2010/052139, filed Oct. 11, 2010, which is incorporated by reference in its entirety and published as WO 2011/045512 on Apr. 21, 2011, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The disclosure relates to managing data storage in a distributed storage space. It should be recalled that a distributed storage system comprises a plurality of data processor devices forming a unified storage space.

By way of example, the storage devices may be a computer, a radiotelephone, a player, e.g. an MP3 type player, a Windows Media Audio player, etc., and more generally any device suitable for storing data.

### BACKGROUND OF THE DISCLOSURE

Nowadays, users have different storage devices for storing content. There are fixed electronic devices such as personal computers, hard disks of the network attached storage (NAS) type, etc. There are also mobile electronic devices such as radiotelephones, cameras, etc. Finally, there are also electronic devices, usually servers, that provide on-line storage spaces (flickR, box.net, . . . ) that are accessible via an Internet network.

Each device has physical and software resources enabling data to be manipulated locally, where manipulation includes reading data and writing data.

A distributed storage system is made up of a plurality of devices for constituting a unified storage space. In other words, a user seeking to write or read a content in a distributed storage system may do so on a device selected from the devices of the distributed storage system.

For this purpose, a management module has the function of managing access to content. To do this, the module stores a list of contents and the respective location(s) of each content in the devices of the distributed storage system.

Thereafter, a user seeking to manipulate a content in the unified storage system views the location(s) of the content via the management module and selects a location at random.

### SUMMARY

The inventors have observed that no information about the devices making up the distributed storage system is made available for making an appropriate selection of one or more devices for use in manipulating the data.

For example, a device may be off, so data cannot be manipulated by that device unless it is restarted. However such restarting gives rise to undesirable energy consumption and to latency.

The device may also be electrically powered but in a standby state. Putting electronic equipment into a standby state is a practice that is nowadays widespread for limiting energy consumption. The standby state consists in no longer powering the resources of the device in question, where such resources may be a hard disk, a fan, a screen, etc. The problem is that restarting a device in a standby state, like restarting a device that is off, gives rise to undesirable energy consumption and latency.

An illustrative embodiment of the invention seeks to improve that situation.

To this end, an embodiment of the invention provides a method of selecting at least one device for manipulating data, said at least one device being selected from a plurality of devices forming a distributed storage space, the method being characterized in that selection of a device includes a step of taking account of at least one item of technical information associated with the device.

The selection of a device is thus based on technical information relating to the devices making up the distributed storage system. The technical information provides an indication about the capacity and/or the performance of a device with reference to carrying out a manipulation. Thus, when a user seeks to manipulate data, i.e. to read or write data, the user or the above-described management module no longer selects a device blindly, but rather selects a device appropriately as a function of the effect that is desired.

The desired effect may be to reduce the energy consumption associated with manipulating data, or to reduce latencies due to restarting a device that is off or on standby, or both effects simultaneously.

As mentioned above, the devices of the distributed storage system may be in various different respective electrical states involving respective amounts of energy consumption when manipulating data. A first variant of the method takes the electrical state of the device into account. Thus, if the storage system has two devices and if one of the devices is in the standby state while the other device is ready for use, then the method gives preference to manipulating data on the device that will give rise to the least energy consumption on being used, i.e. usually the device that is ready for use. Thus, if the same content is stored on two distinct devices, the device that consumes the least energy is used for reading the content. Examples below illustrate devices associated with respective electrical states and one or more devices being selected as a function of their electrical state.

A device may be found in a plurality of states including a ready-for-use state. Thus, in this first variant, said at least one selected device is the device for which the electrical state is a ready-for-use state. As can be seen from the implementations described below, when a device in the ready-for-use state is selected, the overall level of energy consumption of the distributed storage system is lower than it would if the selected device were in the standby state or the OFF state.

Each device provides higher or lower performance depending on its hardware and software capabilities; each device is thus capable of performing a manipulation at a respective speed of execution. In a second variant, that may be used on its own or in association with the first variant, the technical information is information associated with the execution time for a manipulation by the device in question. This characteristic makes it possible to give preference to a device that is suitable for manipulating data as quickly as possible.

In a hardware aspect, an embodiment of the invention relates to a module suitable for being installed in a device, said module being suitable, on receiving a data manipulation request, for selecting at least one device for manipulating the data, the device being selected from a plurality of devices forming a distributed storage space, the module being characterized in that it includes means for taking account of at least one respective item of technical information associated with each device when selecting said at least one device.

In another hardware aspect, an embodiment of the invention relates to a computer system comprising a plurality of devices forming a distributed storage stage, at least one device being suitable for being selected for manipulating data, the system being characterized in that it includes means for taking account of at least one respective item of technical information associated with each device when selecting said at least one device.

An embodiment of the invention also relates to a device characterized in that it comprises a module as defined above.

Finally, an embodiment of the invention also relates to a computer program including code instructions that, when the program is executed, perform the steps of the method defined above, i.e. a step of taking account of at least one item of technical information associated with a device when selecting a device for manipulating data.

One or more embodiments of the invention can be better understood on reading the following description given by way of example and made with reference to the accompanying drawing.

### BRIEF DESCRIPTION OF THE DRAWING

FIG. 1 shows a computer system illustrating a first implementation of a method of the invention for managing data storage.

FIG. 2 shows a computer system illustrating a second implementation of a method of the invention for reading data.

### DETAILED DESCRIPTION OF AN IMPLEMENTATION ILLUSTRATING THE INVENTION

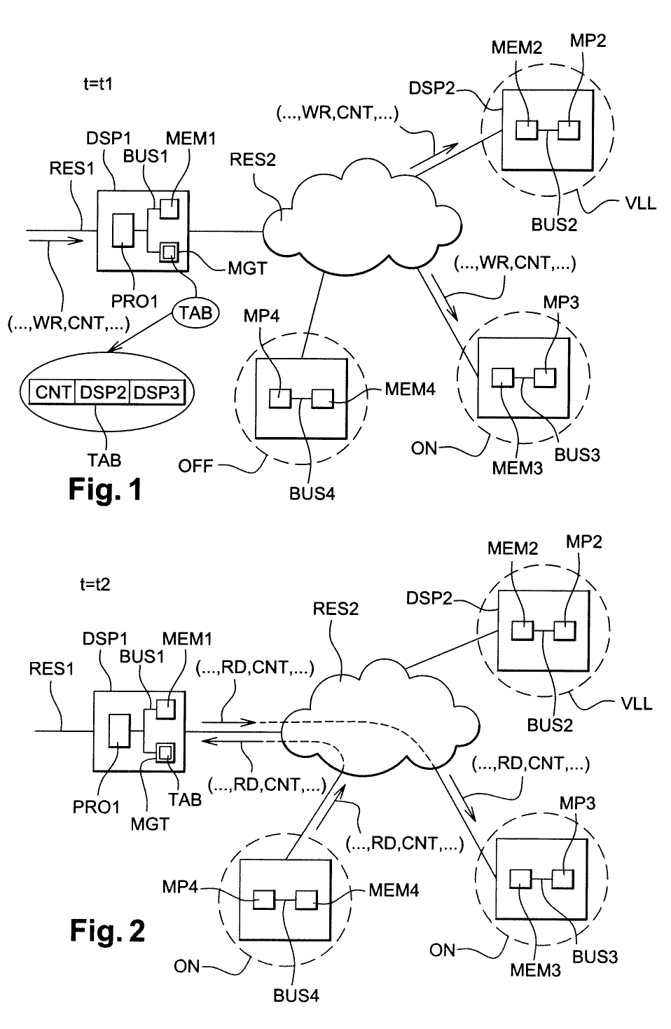

FIG. 1 shows a distributed data storage system SYS having a plurality of devices DSP1-DSP4 on which data can be manipulated.

It should be understood that “manipulation” includes “writing” and “reading” data in a memory, and that “writing” includes creating and modifying data.

In this example, the system SYS has four devices connected together by means of a network, referred to as the “second” network in the description below, which network forms a distributed storage space. It should be recalled that a distributed storage space makes it possible to distribute data storage over one or more storage devices. By way of information, it should be recalled that storing the same content on a plurality of devices makes it possible to improve the availability of the data.

In this example, the first device DSP1 corresponds to a home gateway of the Livebox type (trademark registered by the Applicant); the second device DSP2 corresponds to an MP3 type player suitable for reading and recording MP3 type data; the third device DSP3 corresponding to a radiotelephone; and the fourth device DSP4 corresponding to a personal computer.

In this example, each device includes at least one processor and at least one memory suitable for storing data. Specifically, the gateway DSP1 has a processor PRO1, referred to as the “first” processor, that is connected to a memory MEM1, referred to as the “first” memory, by means of a bus BUS1, referred to as the “first” bus. In this example, the gateway DSP1 is not used as storage means for handling data by the method of an embodiment of the invention.

The player DSP2 comprises a processor PRO2, referred to as the “second” processor, connected to a memory MEM2 referred to as the “second” memory, by means of a bus BUS2, referred to as the “second” bus. The radiotelephone DSP3 includes a processor PRO3, referred to as the “third” processor, connected to a memory MEM3, referred to as the “third” memory, via a bus BUS3, referred to as the “third” bus. The computer DSP4 includes a processor PRO4, referred to as the “fourth” processor, connected to a memory MEMO, referred to as the “fourth” memory, by means of a bus BUS4, referred to as the “fourth” bus.

The gateway DSP1 is connected both to a first network RES1 and to the second network RES2. By way of example, the first network RES1 is the Internet. The second network RES2 as used in this example is a WiFi type wireless network. Each device DSP1 to DSP4 is thus fitted with data transceiver means for transmitting and receiving data in accordance with the 802.11 standard.

In this example, a device may have three states. An ON first state, in which the device is ready for use, a VLL second state in which the device is in a standby state, and an OFF third state in which the device is off. This example is restricted to three electrical states, however it is naturally possible for other states to be taken into account when implementing an embodiment of the invention. The number of states may be less than or greater than three. The details of each of the states are not described below since they are not relevant for explaining the invention.

It is also specified that a device that is ready for use is a device that is powered, that is ready to operate, and that does not have its hardware and/or software resources in a standby state.

The method of an exemplary embodiment of the invention requires an energy consumption balance for each device forming the distributed storage system.

In general, a device in the ON state, i.e. that is ready for use consumes more energy than a device in the VLL standby state, which in turn consumes more energy than a device in the OFF state.

In the description below, it is assumed that:

Cons(ON) represents the consumption of a device that is ON and ready for use;

Cons(VLL) represents the consumption of the device in the standby state; and

Cons(OFF) represents the consumption of the device when off.

In this example, the following relationship may be written:

Cons(ON)>Cons(VLL)>Cons(OFF)

where “>” is the mathematical symbol for “greater than”.

This assumption is not true under all circumstances, but can be used as a basis for this example. A counter-example is that of a server in the standby state and an MP3 type player in the ready state; in this configuration the server in question in the standby state may consume more energy than a player that is ready for use.

Consideration is given to a system at an instant t=t0, the system having (X+Y+Z) devices in the following respective states:

X devices in the ON state, ready for use;

Y devices in the VLL state, on standby; and

Z devices in the OFF state.

X, Y, and Z are integers, and the symbol “+” represents addition.

In the above configuration, if a device that is ready for use is selected for a manipulation, i.e. reading or writing, then after selection the system will still have the same number of devices in the ON state, the same number of devices in the VLL standby state, and the same number of devices in the OFF state. In this configuration, the overall consumption, referred to below as the “first” consumption and written Cons1, may be written using the following mathematical relationship:

Cons1=X(Cons(ON))+Y(Cons(VLL))+Z(Cons(OFF))

In the above system, if a device in the VLL standby state is selected for manipulation, then once it has been selected there will be (X+1) devices in the ON state, (Y−1) devices in the VLL standby state, and the same number Z of devices in the OFF state. In this configuration, in application of the above assumption, i.e. any device in the ON state consumes more energy than any device in the VLL state, the overall consumption Cons2 of the system, referred to as the “second” consumption, is greater than the first consumption Cons1. This second consumption may be written using the following mathematical relationship:

Cons2=(X+1)(Cons(ON))+(Y−1)(Cons(VLL))+Z(Cons(OFF))

In the above configuration, if a device in the OFF state is selected for manipulation, then after the selection there will be (X+1) devices in the ON state, Y devices in the VLL standby state, and (Z−1) devices in the OFF state. In this configuration, and in application of the above assumption, the overall consumption Cons3 of the system, referred to as the “third” consumption is greater than the above two consumptions, i.e. is greater than the first consumption Cons1 and greater than the second consumption Cons2. This third consumption Cons3 may be written using the following mathematical relationship:

Cons3=(X+1)(Cons(ON))+Y(Cons(VLL))+(Z−1)(Cons(OFF))

As a result the following mathematical relationship applies:

Cons1<Cons2<Cons3

In an embodiment of the invention, selecting a device for data manipulation comprises a step of taking account of at least one item of technical information associated with the device. In this example, the device that is selected for data manipulation is selected as a function of the energy consumption of said device in order to perform a data manipulation.

For this purpose, a management module MGT has the function of managing this selection.

Thus, in this example, a device in the ON state is preferred over devices in a standby state or an OFF state. Also, if the system SYS does not have any devices in the ON state, preference is given to a device in the VLL standby state over a device in the OFF state. It is assumed above that a device remaining in the same state will consume less energy than a device changing state to go from either the standby state or the OFF state to the ON state.

In this example, the module MGT is situated in the first device DSP1 under the control of the first processor PRO1; nevertheless, the location of this device may be arbitrary.

Two examples are described with reference to FIGS. 1 and 2, respectively. A first example corresponds to a first stage during which data is to be stored using the method of an embodiment of the invention, and a second example corresponds to a second stage, later than the first stage, during which the data stored with reference to the first example is accessed from the personal computer DSP4 using the method of an embodiment of the invention.

In the first example, it is assumed that at instant t=t1, the player DSP2 is in a standby state, that the radiotelephone DSP3 is in an ON state, and that the computer is in the OFF state. In this first example, X=1, Y=1, and Z=1.

During a first step, data from the first network RES1 is received by the gateway DSP1. The nature of the data may be arbitrary. It is assumed that the data comprises musical content CNT. In FIG. 1, the received signal thus includes at least two parameters, namely a write command WR and the content CNT, ( . . . , WR, CNT, . . . ), the ellipses indicating that other parameters may be added such as the identifier of the gateway, etc. These other parameters are not relevant in explaining the invention.

During a second step, the first processor PRO1 receives the signal including the write command WR and the content CNT, and sends a command to the module MGT to determine the device(s) on which the content CNT can be stored.

During a third step, the module MGT, having knowledge of the electrical state in which each of the devices is to be found, determines which storage device(s) is to be used so as to consume the least energy.

Starting from the above-mentioned considerations, the module MGT gives preference to writing on the radiotelephone DSP3 since it is in the ON state.

Below, it is accepted that writing is always performed on two devices so as to improve the subsequent availability of the data. Once the radiotelephone has been selected, there remain two devices that might be selected, namely the second device and the fourth device. In application of the above-mentioned considerations, the module will give preference to performing data manipulation on the player DSP3 since it is in the standby state.

Thus, during a fourth step, the module MGT selects the radiotelephone DSP3 and the player DSP2.

During a fifth step, the first processor PRO1 receives the selection made by the module MGT.

During a sixth step, the first processor PRO1 transmits a write command both to the radiotelephone DSP3 and to the player DSP2, respectively.

During a seventh step, the radiotelephone DSP3 and the player DSP2 execute the respective write commands.

During an eighth step, a correspondence table TAB is created in which an identifier for the content CNT is stored together with the location of the content CNT in the distributed storage system. In this example, the table contains the identifier of the content, the identifier of the radiotelephone DSP3, and the identifier of the player DSP2.

In this example, this first stage is followed by a second stage of reading the same content. In this new example, it is assumed that at the instant t=t2, the computer DSP4 is on and that the request to read the content is issued from the computer. In this example, it is also considered that the player DSP2 and the radiotelephone DSP3 are in the same state as in the preceding example, i.e. respectively in the standby state and in the ON state. In this example, X=2, Y=1, and Z=0.

This second stage comprises the following steps: During a first step, a user request access to the content CNT. The request in question is sent to the module MGT that manages access to the content.

During a second step, the module MGT receives a signal including a read command RD together with an identifier of the content CNT for which read access is requested. In FIG. 2, the signal in question is referenced ( . . . , RD, CNT, . . . ).

During a third step, the module MGT consults the correspondence table TAB and identifies the device(s) on which the content CNT is stored. In this example, the devices concerned are the player DSP2 and the radiotelephone DSP3.

During a fourth step, the module MGT consults the state of the devices identified during the third step and selects a device as a function of its state. Starting from the above-specified considerations, the module MGT gives preference to reading via the radiotelephone DSP3 since it is in the ON state.

In the above examples, the module MGT always has a state available for each device. This state is updated periodically, either on request of the module MGT or on receiving information from a device that has changed state or that is about to change state. For example, the module may periodically send signals to the devices making up the distributed storage system, and if the module does not receive a response from the device, the module assumes that the device in question is in the VLL standby state or in the OFF state. Each device may also be fitted with a software module suitable for sending a change of state or a predicted change of state to the management module.

The above examples are associated with energy consumption. Another implementation could consist in selecting a device as a function of the execution time estimated for a manipulation by the device in question. That makes it possible to give preference to a device that is suitable for manipulating data faster than other devices in the distributed storage system.

1. A method of selecting at least one device for manipulating data, wherein the method comprises:
selecting said at least one device from a plurality of devices forming a distributed storage space, wherein selecting comprises:
a step of taking account of at least one item of technical information associated with the device.

2. A method according to claim 1, wherein the devices have respective electrical states involving respective consumptions of energy during data manipulation, and wherein said at least one technical characteristic is the electrical state of the device.

3. A method according to claim 2, wherein the electrical states comprise a ready-for-use state, and wherein said at least one selected device is the device for which the electrical state the ready-for-use state.

4. A method according to claim 1 wherein the devices perform manipulations at respective speeds of execution, and wherein the technical information is associated with the execution time for a manipulation by the device in question.

5. A module, said module comprising:
a processor configured to receive a data manipulation request an on receipt of the request select at least one device for manipulating the data, the at least one device being selected from a plurality of devices forming a distributed storage space, the processor further being configured to take account of at least one respective item of technical information associated with each device when selecting said at least one device.

6. A computer system comprising:
a plurality of devices forming a distributed storage stage, at least one of the devices being configured to be selected for manipulating data, and
means for selecting the at least one device by taking account of at least one respective item of technical information associated with each device when selecting said at least one device.

7. A device comprising the module of claim 5.

8. A non-transitory computer-readable memory comprising a computer program including code instructions that, when the program is executed, perform a method of selecting at least one device for manipulating, wherein the instructions comprise:
instructions configured to select said at least one device from a plurality of devices forming a distributed storage space by taking account of at least one item of technical information associated with the device.
